(19) United States
(12) Patent Application Publication
(10) Pub. No.: US 2013/0041634 A1
(43) Pub. Date: Feb. 14, 2013

(54) Initial Configuration of a Blank in Sheet Metal Forming Simulation

(71) Applicants: Xinhai Zhu, Pleasanton, CA (US); Li Zhang, Rochester Hills, MI (US)

(72) Inventors: Xinhai Zhu, Pleasanton, CA (US); Li Zhang, Rochester Hills, MI (US)

(73) Assignee: LIVERMORE SOFTWARE TECHNOLOGY CORPORATION, Livermore, CA (US)

(21) Appl. No.: 13/208,207

(22) Filed: Aug. 11, 2011

(51) Int. Cl. G06F 17/10

(52) U.S. Cl. 703/2

(57) ABSTRACT

An improved system and method of creating an initial configuration of a finite element mesh model of a blank sheet metal used in a computer simulation of sheet metal forming process is disclosed. According to one aspect of the present invention, the finite element mesh model of the blank is initially configured as a flat plate without any weight before performing the gravity loading phase of the simulation. A user-specified initial imperfection is then applied to the initial flat plate model so that a desired bent shape occurs predictably.

### FIELD OF THE INVENTION

The present invention generally relates to systems and methods used in numerical simulation of sheet metal forming process, more particularly to numerically simulating an initial configuration of a blank sheet metal.

### BACKGROUND OF THE INVENTION

Sheet metal forming has been used in the industry for years for creating metal parts from a blank sheet metal, for example, automobile manufacturers and their suppliers produce many of the parts using sheet metal forming. One of the most used sheet metal forming processes is referred as draw forming or stamping. Cross-section view of an exemplary draw stamping set up is shown in FIG. 1. To create a part or product, it involves a hydraulic or mechanical press pushing a specially-shaped die 110 onto a matching punch 130 with a piece of blank sheet metal 120 or workpiece in between. The blank 120 is initially supported by a binder 108 and/or the punch 130. The binder 108 is sometimes referred to as binder ring, ring or blank holder, which is situated on top of a die cushion 106 that is actuated by air, oil, rubber or springs 107. Exemplary products made from the sheet metal forming process include, but are not limited to, car hood, fender, door, automotive fuel tank, kitchen sink, aluminum can, etc. In deep drawing, the depth of a part or product being made is generally more than half its diameter. As a result, the blank is stretched and therefore thinned in various locations due to the geometry of the part or product. The part or product is only good when there is no structural defect such as material failure (e.g., cracking, tearing, wrinkling, necking, etc.).

Traditional, developing a metal forming process is a tedious trial and error procedure that requires creating and/or modifying physical prototypes. The traditional approach is not only costly, but time consuming. With advent of the finite element method together with modern computer systems, the traditional development of a metal forming process has been replaced in most part with the help of a computer simulation. The simulation can reduce the time to market significantly, for example, most of the time consuming physical prototype creations/modifications are replaced by manipulating a finite element mesh model (e.g., a mesh model of die face in various configurations).

A metal forming process simulation is performed in a number of stages or phases. FIG. 2 is a flow diagram showing different phases of an exemplary metal forming simulation. The simulation starts with the first step referred to as “gravity loading” 202, which simulates a blank deforms under its own weight before draw forming starts. The “gravity loading” phase 202 is an artificial simulation step because the blank sheet metal does not require such procedure in real-world. The gravity acts on the blank automatically.

Next step is referred to as “binder closing” 204, in which the blank is clamped down by the binder. Then, in “die punching” step 206, the press die is pushed down onto the match punch with the blank in between. After the blank has been pressed, the next step “die retracting” 208 follows allowing for springback of the pressed blank and other steps (not shown). The present invention is directed to simulating of the “gravity loading” phase 202.

In prior approaches, a blank has been modeled with a finite element mesh model with a flat geometry (i.e., the blank starts as a flat plate without any weight). Then based on the mass density of the blank material, the “gravity loading” phase is simulated by conducting a finite element analysis of the blank under its own weight. The resulted or gravity-loaded blank will rest on top of the binder and/or the top of the punch depending upon the geometry of the set up. For subsequent simulations, the geometry of gravity-loaded blank is the starting configuration.

However, blank's flat initial zero-weight geometry has sometimes caused problems in computer simulation of the gravity loading. In real-world, a substantially large piece of flat sheet metal blank (e.g., a workpiece for a car's hood, fender, or door) may naturally bend in more than one bent shape (e.g., sagging or hogging). Any of these bent shapes is equally likely to occur unless the blank is manipulated (e.g., shaking or bending) either by die makers in die tryout stage or by suction cups in a stamping press to result in a desirable bent shape prior to the blinder closing and die punching. A metal forming process simulation application module has been created and configured to simulate such phenomena accordingly. As a result, a blank with flat initial geometry creates uncertainty in a gravity loading simulation and hence affecting the results of subsequent phases.

It would therefore be desirable to have an improved system and method for specifying and creating an initial configuration of a blank sheet metal to ensure more reliable simulation results in a computer simulation of a sheet metal forming process.

### BRIEF SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

An improved system and method of creating an initial configuration of a finite element mesh model of a blank sheet metal used in a computer simulation of sheet metal forming process is disclosed. According to one aspect of the present invention, the finite element mesh model of the blank is initially configured as a flat plate without any weight before performing the gravity loading phase of the simulation. A user-specified initial imperfection is then applied to the initial flat plate model so that a desired bent shape occurs predictably.

According to another aspect, the initial imperfection is created by converting the flat geometry into a curved one (e.g., a plate having a curvature) based on user-specified directives. The directives many include, are not limited to, a radius and a center for bending the flat plate configuration of the initial finite element mesh model before performing the “gravity loading” phase of the simulation. Bending of the initial flat plate configuration can be applied to any axis with respect to the initial flat plate geometry. According to yet another aspect, the initial imperfection may have a number of forms, for example, a concave curvature (sagging) or a convex curvature (hogging).

One of the objects of the present invention is to ensure more reliability of a computer simulation of a sheet metal forming process.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIG. 1 is a diagram illustrating an elevation cross-section view of an exemplary deep draw sheet metal forming set up;

FIG. 2 is a flow diagram showing various phases of an exemplary sheet metal forming process simulation;

FIGS. 3A-3B are diagrams each illustrates an exemplary scheme of creating a numerical model representing a blank sheet metal including user-specified initial imperfection, according to an embodiment of the present invention;

FIGS. 4A-4D are diagrams illustrating various bent shapes of a numerical model representing an exemplary blank sheet metal in accordance with the present invention;

FIGS. 5A-5B are diagrams showing hogging and sagging shapes of an exemplary blank sheet metal in accordance with the present invention;

FIG. 6 is a flowchart illustrating an exemplary process of creating an initial configuration of a blank sheet metal having an initial imperfection in a sheet metal forming process simulation, according to an embodiment of the present invention; and

FIG. 7 is a functional block diagram showing salient components of an exemplary computer, in which an embodiment of the present invention may be implemented.

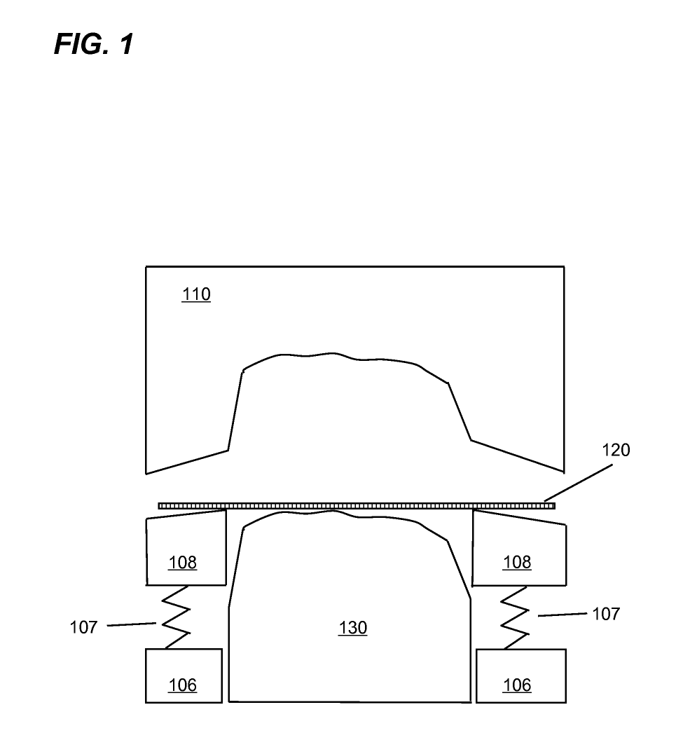

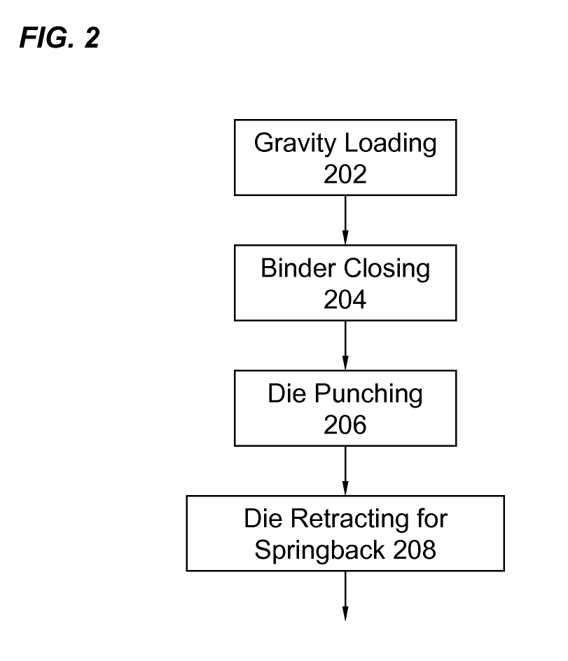

### DETAILED DESCRIPTION

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures, and components have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

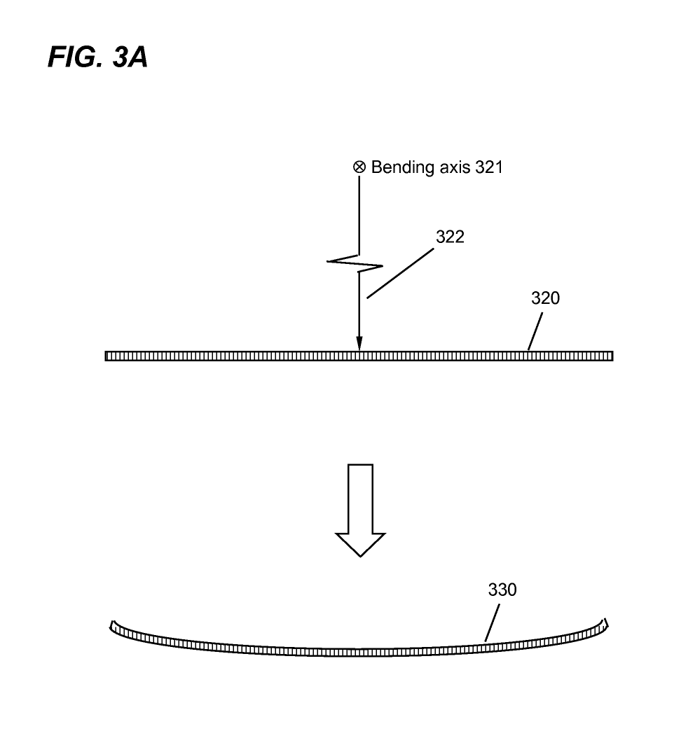

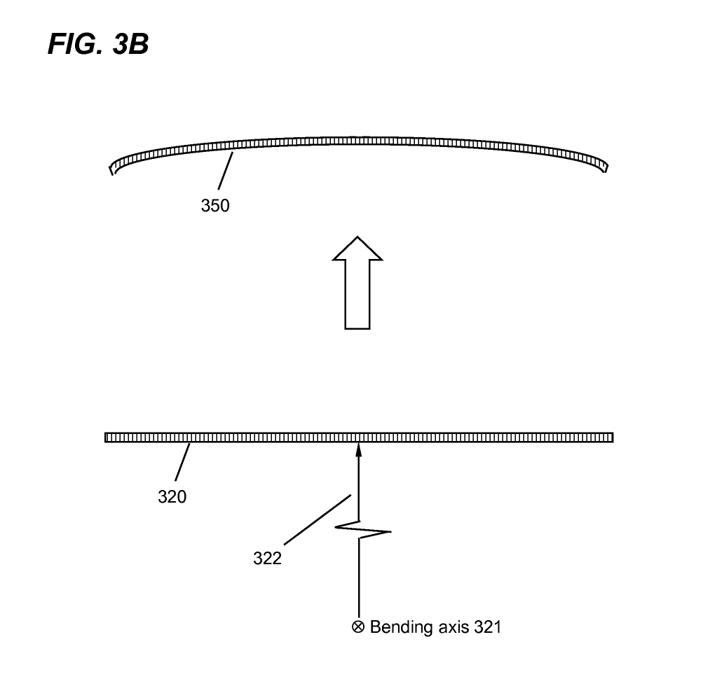

Embodiments of the present invention are discussed herein with reference to FIGS. 3A-7. However, those skilled in the art will readily appreciate that the detailed description given herein with respect to these figures is for explanatory purposes as the invention extends beyond these limited embodiments.

An improved system and method of creating an initial configuration of a finite element mesh model of a blank sheet metal used in a computer simulation of sheet metal forming process is disclosed. The finite element mesh model of the blank is initially configured as a flat plate without any weight before performing the gravity loading phase of the simulation. A user-specified initial imperfection is then applied to the initial flat plate model so that a desired bent shape occurs predictably. The initial imperfection will avoid the arbitrary occurrence of different bent shapes during the computer simulation.

Referring first to FIG. 3A, it is shown an exemplary scheme of creating a numerical model 330 representing a blank sheet metal 320 including user-specified initial imperfection, according to an embodiment of the present invention. The cross-sectional profile of the blank sheet metal 320 is shown to have a flat geometry originally. In other words, a finite element mesh model is set up originally as a flat plate to represent the blank without any deformation. To avoid the unpredictable occurrence of multiple equal likelihood bent shapes, a user-specified initial imperfection is introduced. According to one embodiment, the impaction is in forms of adding curvature to the flat geometry, for example, the flat blank model being pre-bent. One example of the user-specified directives includes specifying a radius 322 and a vector to represent an axis of bending 321. Radius 322 defines a center of rotation away from the blank. The axis of the bending 321 is configured for bending the blank in a prescribed direction. In FIG. 3A, the axis 321 points into the paper. The blank 320 is bent into a sagging or concave shape 330 about the axis 321 at a center located at one radius 322 away from the blank. Additionally, other features can be included, for example, a coordinate of most-bent location (e.g., the blank's center of gravity).

FIG. 3B shows a hogging or convex shape 350 can be achieved by placing the rotation center on the other side of the blank 320.

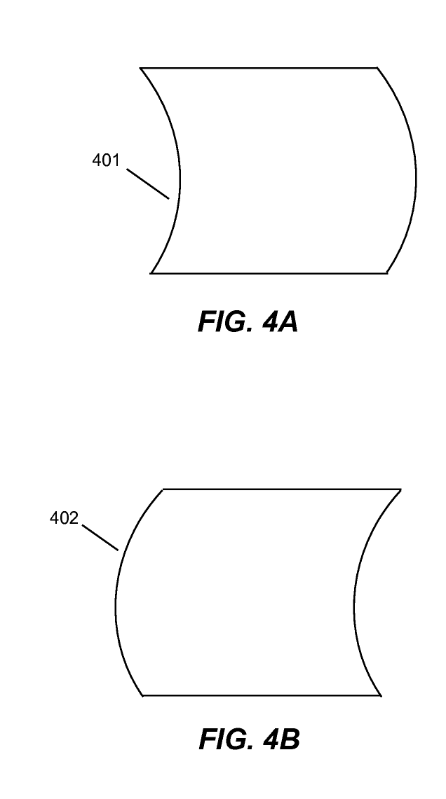

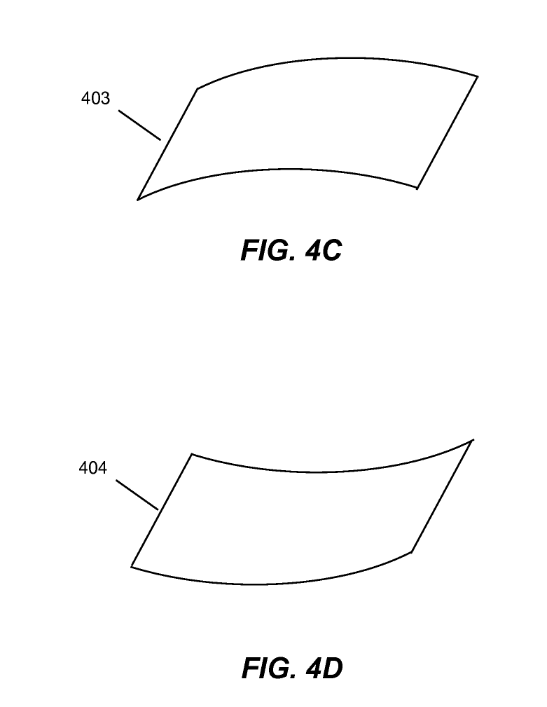

Sagging and hogging shapes 401-404 about two orthogonal axes of a rectangular plate are shown in FIGS. 4A-4D. One of these bent shapes is used for creating an initial imperfection of the blank sheet metal. FIG. 4A shows a sagging or concave shape 401 of the plate about a first axis (axis not shown), while a hogging or convex shape 402 about the same axis is shown in FIG. 4B.

FIG. 4C and FIG. 4D show hogging 403 and sagging shapes 404 about a second axis (orthogonal to the first axis, not shown) of the plate, respectively.

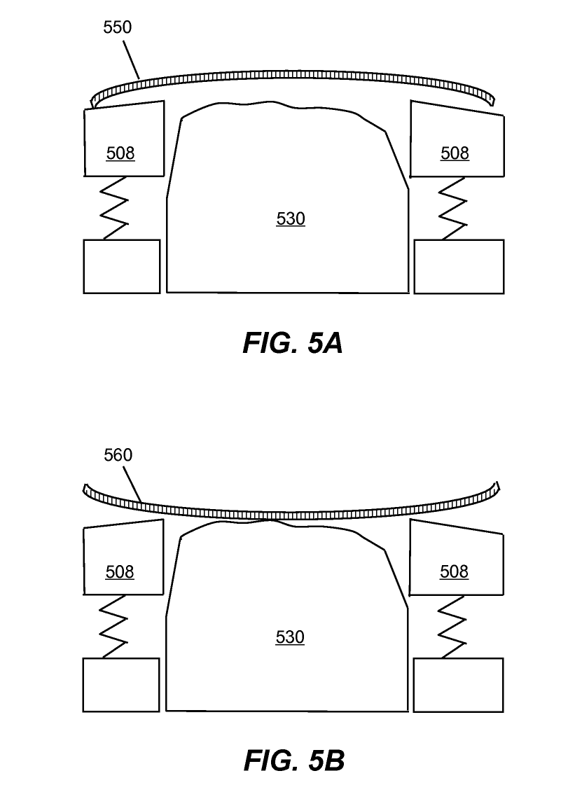

In the real-world of sheet metal forming, blanks are loaded to the draw press with suction cups, which sometimes creating an initial imperfection. FIG. 5A shows cross-section profiles of a blank with hogging or convex shape 550 on top of the die press (i.e., binder 508 and punch 530), while a sagging or concave shape 560 is shown in FIG. 5B.

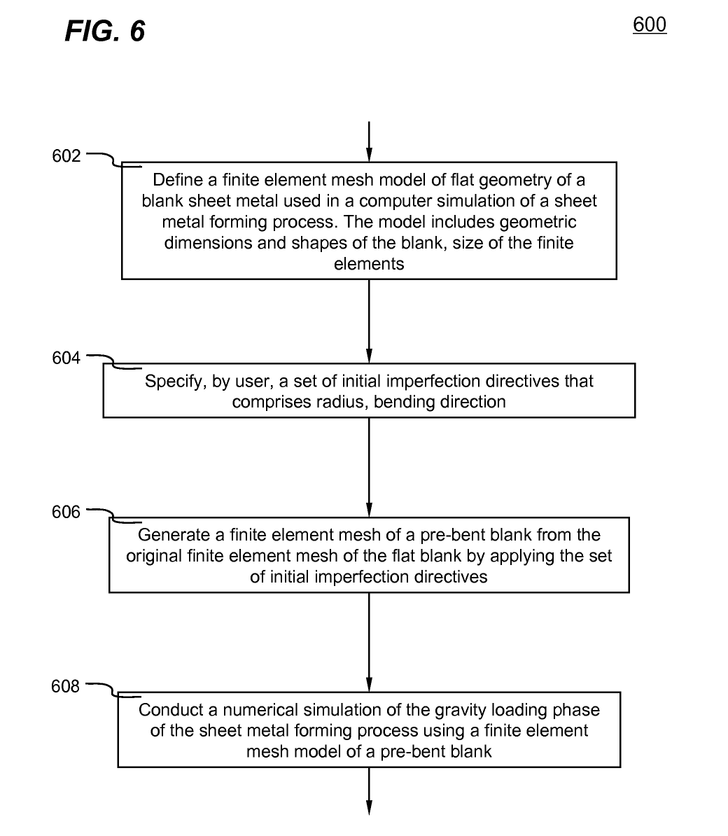

Referring now to FIG. 6, it is shown an exemplary process 600 of creating an initial configuration of a blank sheet metal having an initial imperfection in a sheet metal forming process simulation, according to an embodiment of the present invention. Process 600 may be implemented in software with a set of user specified directives.

Process 600 starts at step 602, a finite element mesh model of a flat geometry of a blank sheet metal is defined. The finite element mesh model includes geometric dimensions and shapes of the blank. Generally, the finite element mesh model includes a plurality of shell elements. The size of finite element is also defined.

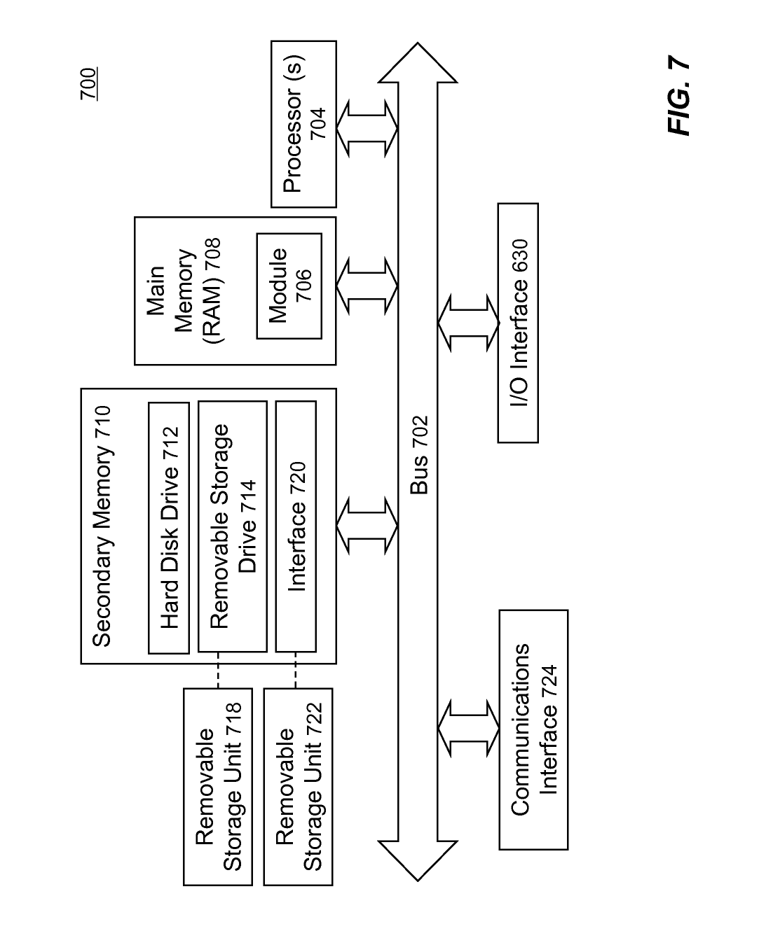

Next, at step 604, user (i.e., engineer, designer of the sheet metal forming process) specifies a set of directives to create an initial imperfection to the flat blank model. Exemplary directives include a set of pre-bending instructions that comprises of radius, bending axis, etc. (e.g., FIGS. 3A-3B). Then, the directives are applied to the flat blank model at step 606, which is generally performed with a computer system (e.g., computer system 700 of FIG. 7). For the pre-bending instructions, the flat blank model is converted into a finite element mesh model of a pre-bent blank sheet metal either in sagging (concave) or hogging (convex) shape. Finally, at step 608, the gravity loading phase of the sheet metal forming computer simulation is performed using the pre-bent blank model.

According to one aspect, the present invention is directed towards one or more computer systems capable of carrying out the functionality described herein. An example of a computer system 700 is shown in FIG. 7. The computer system 700 includes one or more processors, such as processor 704. The processor 704 is connected to a computer system internal communication bus 702. Various software embodiments are described in terms of this exemplary computer system. After reading this description, it will become apparent to a person skilled in the relevant art(s) how to implement the invention using other computer systems and/or computer architectures.

Computer system 700 also includes a main memory 708, preferably random access memory (RAM), and may also include a secondary memory 710. The secondary memory 710 may include, for example, one or more hard disk drives 712 and/or one or more removable storage drives 714, representing a floppy disk drive, a magnetic tape drive, an optical disk drive, etc. The removable storage drive 714 reads from and/or writes to a removable storage unit 718 in a well-known manner. Removable storage unit 718, represents a floppy disk, magnetic tape, optical disk, etc. which is read by and written to by removable storage drive 714. As will be appreciated, the removable storage unit 718 includes a computer usable storage medium having stored therein computer software and/or data.

In alternative embodiments, secondary memory 710 may include other similar means for allowing computer programs or other instructions to be loaded into computer system 700. Such means may include, for example, a removable storage unit 722 and an interface 720. Examples of such may include a program cartridge and cartridge interface (such as that found in video game devices), a removable memory chip (such as an Erasable Programmable Read-Only Memory (EPROM), Universal Serial Bus (USB) flash memory, or PROM) and associated socket, and other removable storage units 722 and interfaces 720 which allow software and data to be transferred from the removable storage unit 722 to computer system 700. In general, Computer system 700 is controlled and coordinated by operating system (OS) software, which performs tasks such as process scheduling, memory management, networking and I/O services.

There may also be a communications interface 724 connecting to the bus 702. Communications interface 724 allows software and data to be transferred between computer system 700 and external devices. Examples of communications interface 724 may include a modem, a network interface (such as an Ethernet card), a communications port, a Personal Computer Memory Card International Association (PCMCIA) slot and card, etc. Software and data transferred via communications interface 724 are in the form of signals 728 which may be electronic, electromagnetic, optical, or other signals capable of being received by communications interface 724. The computer 700 communicates with other computing devices over a data network based on a special set of rules (i.e., a protocol). One of the common protocols is TCP/IP (Transmission Control Protocol/Internet Protocol) commonly used in the Internet. In general, the communication interface 724 manages the assembling of a data file into smaller packets that are transmitted over the data network or reassembles received packets into the original data file. In addition, the communication interface 724 handles the address part of each packet so that it gets to the right destination or intercepts packets destined for the computer 700. In this document, the terms “computer program medium” and “computer usable medium” are used to generally refer to media such as removable storage drive 714, and/or a hard disk installed in hard disk drive 712. These computer program products are means for providing software to computer system 700. The invention is directed to such computer program products.

The computer system 700 may also include an input/output (I/O) interface 730, which provides the computer system 700 to access monitor, keyboard, mouse, printer, scanner, plotter, and alike.

Computer programs (also called computer control logic) are stored as application modules 706 in main memory 708 and/or secondary memory 710. Computer programs may also be received via communications interface 724. Such computer programs, when executed, enable the computer system 700 to perform the features of the present invention as discussed herein. In particular, the computer programs, when executed, enable the processor 704 to perform features of the present invention. Accordingly, such computer programs represent controllers of the computer system 700.

In an embodiment where the invention is implemented using software, the software may be stored in a computer program product and loaded into computer system 700 using removable storage drive 714, hard drive 712, or communications interface 724. The application module 706, when executed by the processor 704, causes the processor 704 to perform the functions of the invention as described herein.

The main memory 708 may be loaded with one or more application modules 706 that can be executed by one or more processors 704 with or without a user input through the I/O interface 730 to achieve desired tasks. In operation, when at least one processor 704 executes one of the application modules 706, the results are computed and stored in the secondary memory 710 (i.e., hard disk drive 712). The status of the computer simulation of sheet metal forming process (e.g., finite element analysis results) is reported to the user via the I/O interface 730 either in a text or in a graphical representation.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas a rectangular plate has been shown and described as a blank. Other arbitrary shapes can be used instead, for example, circular, square, triangular, irregular, etc. Additional, a portion of circular arc has been shown and described as the pre-bent geometry of the blank model. Other equivalent curved surfaces can achieve the same, for example, elliptical, parabolic arcs and alike. Furthermore, exemplary bent shapes shown in FIGS. 4A-4D are drawn with certain exaggerated curvatures, other magnitude of curvature can be used instead to achieve the objective. Finally, the curvature has been shown and described as a two-dimensional curvature. Three-dimensional curvature can be used instead for more complicated initial surface. In summary, the scope of the invention should not be restricted to the specific exemplary embodiments disclosed herein, and all modifications that are readily suggested to those of ordinary skill in the art should be included within the spirit and purview of this application and scope of the appended claims.

What is claimed is:

1. A method of creating a finite element mesh model representing a blank used in a sheet metal forming simulation, said method comprising:
defining a first finite element mesh model of a blank with flat geometry in a computer system having an application module for sheet metal forming process simulation installed thereon;
receiving a set of directives for creating an initial imperfection to the blank in the computer system;
converting the first finite element mesh model to a second finite element mesh model of the blank with the initial imperfection by applying the set of directives in the computer system; and
obtaining a third finite element mesh model of the blank by performing a gravity loading phase of the sheet metal forming process simulation using the second finite element mesh model as a starting geometry, the third finite element mesh model being used for next phase of the sheet metal forming process simulation.

2. The method of claim 1, wherein the finite element mesh model includes a plurality of shell finite elements.

3. The method of claim 1, wherein the set of directives includes specifying an axis of bending and a bending radius.

4. The method of claim 3, wherein the axis of bending is defined by a vector.

5. The method of claim 3, wherein the set of directives further comprises specifying a coordinate of most-bent location.

6. The method of claim 1, wherein the initial imperfection comprises one of the blank's bent shapes.

7. The method of claim 6, wherein said one of blank's bent shapes is a sagging or concave shape.

8. The method of claim 6, wherein said one of blank's bend shapes is a hogging or convex shape.

9. A system for creating a finite element mesh model representing a blank used in a sheet metal forming simulation, said system comprising:
an input/output (I/O) interface;
a memory for storing computer readable code for an application module configured for sheet metal forming process simulation;
at least one processor coupled to the memory, said at least one processor executing the computer readable code in the memory to cause the application module to perform operations of:
defining a first finite element mesh model of a blank with flat geometry;
receiving a set of directives for creating an initial imperfection to the blank;
converting the first finite element mesh model to a second finite element mesh model of the blank with the initial imperfection by applying the set of directives; and
obtaining a third finite element mesh model of the blank by performing a gravity loading phase of the sheet metal forming process simulation using the second finite element mesh model as a starting geometry, the third finite element mesh model being used for next phase of the sheet metal forming process simulation.

10. The system of claim 9, wherein the set of directives includes specifying an axis of bending and a bending radius.

11. The system of claim 10, wherein the set of directives further comprises specifying a coordinate of most-bent location.

12. The system of claim 9, wherein the initial imperfection comprises one of the blank's bent shapes.

13. A non-transitory computer readable medium containing computer executable instructions for creating a finite element mesh model representing a blank used in a sheet metal forming simulation by a method comprising:
defining a first finite element mesh model of a blank with flat geometry in a computer system having an application module for sheet metal forming process simulation installed thereon;
receiving a set of directives for creating an initial imperfection to the blank in the computer system;
converting the first finite element mesh model to a second finite element mesh model of the blank with the initial imperfection by applying the set of directives in the computer system; and
obtaining a third finite element mesh model of the blank by performing a gravity loading phase of the sheet metal forming process simulation using the second finite element mesh model as a starting geometry, the third finite element mesh model being used for next phase of the sheet metal forming process simulation.

14. The non-transitory computer readable medium of claim 13, wherein the set of directives includes specifying an axis of bending and a bending radius.

15. The non-transitory computer readable medium of claim 14, wherein the set of directives further comprises specifying a coordinate of most-bent location.

16. The non-transitory computer readable medium of claim 13, wherein the initial imperfection comprises one of the blank's bent shapes.
